(19) United States
(12) Patent Application Publication
(10) Pub. No.: US 2017/0231252 A1
(43) Pub. Date: Aug. 17, 2017

(54) FROZEN CONFECTION MAKER

(71) Applicant: The Decor Corporation Pty Ltd, Scoresby (AU)

(72) Inventor: Ryan James Owen, Belgrave (AU)

(21) Appl. No.: 15/430,253

(22) Filed: Feb. 10, 2017

(30) Foreign Application Priority Data
Feb. 11, 2016 (AU) 2016900461

(51) Int. Cl. A23G 9/22

(52) U.S. Cl. CPC A23G 9/221

(57) ABSTRACT

A frozen confection maker comprising a hollow mould having an open end and a closed end opposite the open end; and a handle assembly having an elongate handle at a first end, a projection at a second end opposite the handle onto which a confection is frozen and an enlarged portion between the first and second ends that sealingly engages with the open end of the mould; wherein the mould is made of a material that is more resilient than the material of the handle assembly.

### CROSS-REFERENCES TO RELATED APPLICATIONS

This application claims the benefit of Australian Patent Application No. 2016900461, filed Feb. 11, 2016, which is hereby incorporated by reference in its entirety for all purposes.

### FIELD OF THE INVENTION

The present invention relates, in general terms, to an improved apparatus and method for the creation of what shall hereinafter be referred to as a frozen confection. More particularly, but not exclusively, the invention relates to an improved apparatus for use in the manufacture/creation of a frozen confection and, thereafter, to facilitate consumption thereof.

### BACKGROUND OF THE INVENTION

Confectionery products such as icy poles, ice creams, etc are and have been for years commercially available in the form of the relevant product frozen around a stick or the like elongate member, with that stick or elongate member being of wood or a suitable plastics material. The principle has been that, once the actual product is consumed, then the stick or elongate member is simply discarded. This is especially the case when such is constructed from wood, a material which does not lend itself to proper, hygienic cleaning for possible re-use.

A number of attempts have also been made to allow for production of such frozen confections on a domestic scale. Whilst such apparatus has found acceptance to an extent, it has been found to exhibit practical disadvantages in terms of flexibility of use, ease of cleaning for re-use, etc.

The present invention seeks to provide an improvement over the available art by providing a method and means for the ready production of an individual iced confection.

Children, and adults for that matter, sometimes find it difficult to grip the wooden stick or the like which, in accordance with known techniques, protrudes from the bottom of an ice cream or ice block of the traditional type as previously in use, and often lose their grip thereon, resulting in the ice cream or ice block being dropped to the ground, and hence wasted. Further, traditional arrangements of ice cream or ice blocks on a stick suffer from the disadvantage that, during consumption, and especially in hot weather, melting and dripping occurs.

### BRIEF SUMMARY OF THE INVENTION

In accordance with one aspect of the present invention there is provided a frozen confection maker comprising: a hollow mould having an open end and a closed end opposite the open end; and a handle assembly having an elongate handle at a first end, a projection at a second end opposite the handle onto which a confection is frozen and an enlarged portion between the first and second ends that sealingly engages with the open end of the mould; wherein the mould is made of a material that is more resilient than the material of the handle assembly to permit sealing engagement between the enlarged mid-portion and the open end.

The invention therefore in once sense relates to a means for holding, and forming, an iced/frozen confection. More particularly it relates to a means for holding, and forming, an iced confection which is re-usable.

Furthermore, an advantage of the present invention is that it seeks to provide an improvement over the known art by providing a maker for forming an iced confection, which is simple in construction and easy to operate, which lends itself to cleaning for re-use, and which includes a means for collection of melted material, thereby making it cleaner to use, especially by children.

Further still, by providing the mould in a material that is more resilient than the material of the handle assembly, a better and more reliable seal may be formed between the enlarged portion and the mould's open end. The resilence of the mould material relative to that of the handle assembly creates a tight seal, preferably around the outside of the englarged portion, that will mitigate leakage of liquids, or flowable contents, from the mould. Accordingly, the maker, once filled with liquid or flowable foodstuff to be frozen, need not be placed upright in a freezer but can be placed at any angle without leakage.

In accordance with another aspect of the present invention there is provided a means for receiving, for freezing prior to consumption, of a liquid foodstuff, said means being in the form of a substantially hollow member of an enlarged diameter at a first, open end thereof, and a reduced diameter at or in the vicinity of the other, closed end thereof, including, depending from the closed end of reduced diameter, a section of a substantially constant diameter, in turn terminating in a funnel-shaped conical end section, of hollow construction, having at least one flap member extending laterally thereof.

In accordance with yet another aspect of the present invention there is provided a means for forming an iced confection, being a combination of the holder and receiving means of the preceding two paragraphs.

Throughout the ensuing specification reference will be made to a particular and preferred embodiment of a maker in accordance with the present invention, for use in the preparation and then the consumption of edible products such as ice confectionary including ice cream, icy poles and iced yoghurt. It should be understood, however, that the invention is not under any circumstances to be considered to be restricted to such a preferred embodiment or mode of usage. Indeed, when used throughout this specification the expression “iced confection” is intended to encompass or refer to ice cream, yoghurt, water, fruit juice, vegetable juice or in fact any type of edible product in liquid form or of a flowable material (e.g. granular) which can be frozen prior to consumption and might melt or otherwise drip during consumption. The expression is therefore also intended to encompass chocolate coated ice creams, biscuit crumb coated ice creams, flavoured ice blocks, frozen cordial and the like, but may extend to food products not traditionally recognised as confectionery.

### BRIEF DESCRIPTION OF THE DRAWINGS

In order that the invention may be more clearly understood and put into practical effect reference will now be made to a preferred embodiment of an apparatus in accordance with the invention. The ensuing description is given by way of non-limitative example only and is with reference to the accompanying drawings, wherein:

FIG. 1 is a top perspective view of an embodiment of frozen confection maker in accordance with the invention, in an engaged condition;

FIG. 2 is an exploded front perspective view from above of the maker of FIG. 1, with the principal parts separated;

FIG. 3 is an exploded rear perspective view, from below of the maker of FIG. 1, with the parts separated;

FIG. 4 is a first side view of the maker of FIG. 1, with the parts separated;

FIG. 5 is a second side view of the maker of FIG. 1, with the parts separated;

FIG. 6 is a top view of the maker of FIG. 4;

FIG. 7 is an underneath view of the maker of FIG. 4;

FIG. 8 is a side view of the maker in an assembled state; and

FIG. 9 is a cross sectional view of the maker of FIG. 8 taken at section 9-9.

### DETAILED DESCRIPTION OF THE INVENTION

The drawings show a preferred embodiment of a device or apparatus for use in the making of a frozen confection. The frozen confection maker 10 comprises two principal components, namely a holder means in the form of a handle assembly, generally designated 1, and a hollow mould or forming means, generally designated 20. The mould is elongated, preferably of conical form, and has an open end 15 and an opposite close end 16. The mould is made of a material that is more resilient than the material of the handle assembly. Examples of possible materials include flexible plastics or rubber, for example silicone.

The handle assembly 1 is preferably formed from a moulded plastics material having a rigidity that is greater than that of the material of the mould. Examples of suitable materials could be plastics, such as polyolefins including polypropylene or high density polyethylene, but it is understood that other food grade materials could be used that are also suitable to freeze. The handle assembly 1 is of an integral construction.

The handle assembly 1 includes an elongate gripping member or handle 2 at a first end and a projection in the form of a stake 5 at an opposite end of the handle assembly. A confection is adapted to be frozen onto the stake 5.

In the preferred embodiment illustrated that handle 2 is in the form of a hollow elongate member, open at one end and closed at the other, which is of a substantially truncated conical shape and substantially circular in cross-section. The handle 2 has a larger outer diameter at the lower open end thereof than at the upper closed end. The handle 2 preferably includes patterning 3, of any suitable type, and/or indicia, on the outer surface thereof and extending over at least part of the longitudinal dimension thereof.

Between the handle 2 and stake 5, but preferably closer to the stake 5, is an enlarged portion, in the form of a flange 4 of the handle assembly 1 that extends radially outwardly from a general longitudinal direction of the handle assembly. The flange 4 is substantially circular and, in the preferred embodiment illustrated is bowl-shaped.

The flange has two main functions. In the process of filling maker 10 and freezing the contents, the flange acts as a barrier sealingly closing off the open end 15 of the mould to create a sealed internal volume of the mould in which contents may be frozen. In use, the flange 4 provides a surface for retaining an iced or frozen confection when the stake 5 (and hence the frozen confection on it) is directed upwardly and further functions as a drip/drop catcher for any of the frozen confection which may melt during consumption.

The stake 5 is disposed substantially centrally of the handle assembly 1 and extends longitudinally thereof and outwardly from a concave side of the bowl-shaped flange 4. In the embodiment illustrated, the stake 5 has a flattened profile to which the confectionery, when frozen, will attach itself and includes one or more discontinuities, grooves or slots 6 at spaced-apart locations on opposite faces of the flattened profile, and at or in the vicinity of the free end thereof. The slots 6 create an uneven surface on the stake 5 that provide grip in assisting the frozen confection attaching to the stake 5.

The mould 20 and the handle assembly 1 are adapted to sealingly engage each other to create a tight leak-proof seal that will provide confidence to a user against liquid contents leaking out of the maker before the contents have frozen. As best shown in FIG. 9, the open end 15 of the mould 20 includes a moulded engagement groove 26 in the inclined side wall of the conical-shaped mould 20, so that as flange 4 is slidingly inserted into open end 15 it steps, or positively locates, into the groove 26. The resilience of the mould material acts to stretch the open end of the mould around, and bear against, flange 4 of the handle assembly 1 to effect a seal.

Additionally, the outer diameter of flange 4 may be larger than an inner diameter of the mould at the open end, or at the engagement groove 26, to facilitate in a leak-proof seal being formed between the mould 20 and handle assembly 1.

The mould 20 is preferably of an integral construction and formed from a suitable resilient or flexible material such as, for example, food grade silicone. It should be understood, however, that the material of construction could include other materials including rubber or a plastics that is more resilient than the material of the handle assembly 1. The material of construction should be durable, food-safe and freezable without affecting the properties of the material.

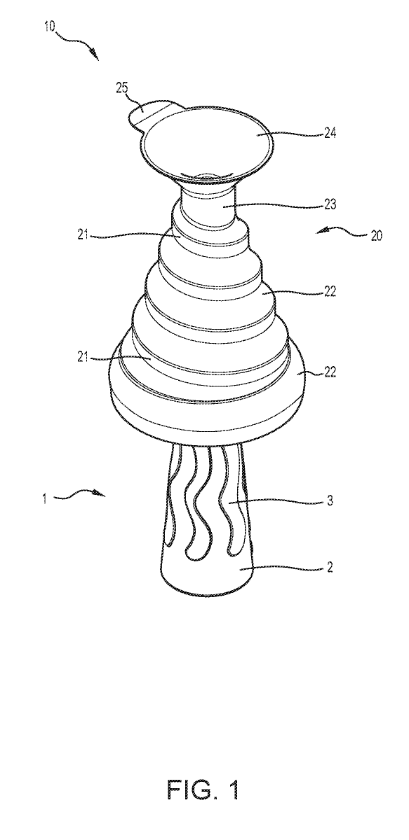

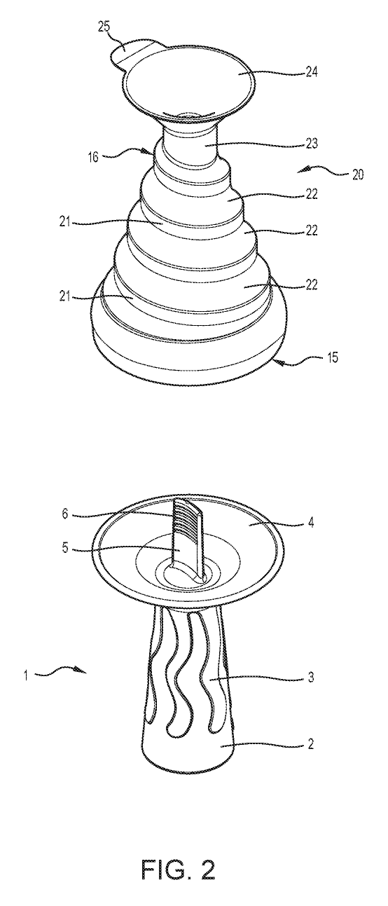

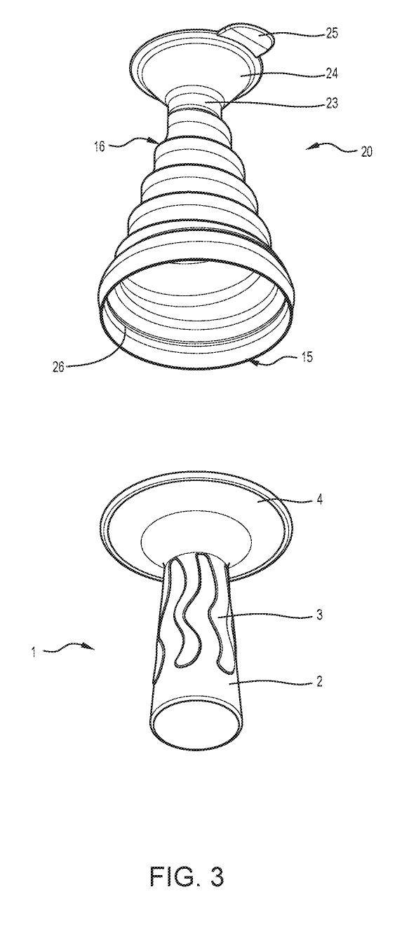

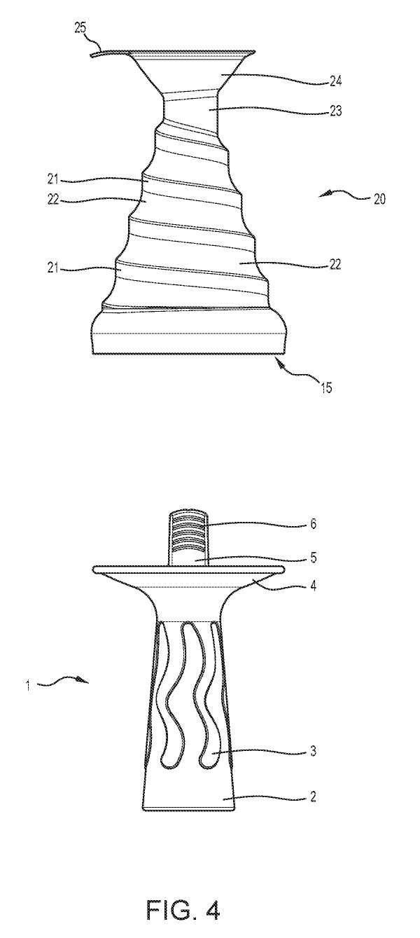

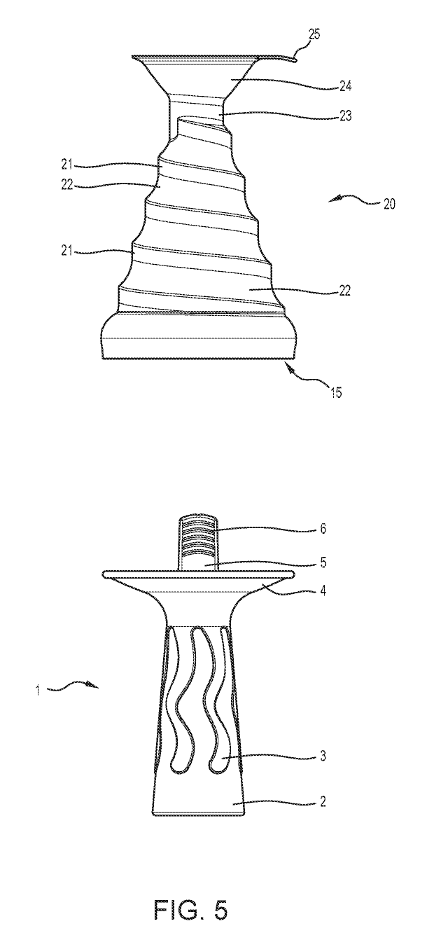

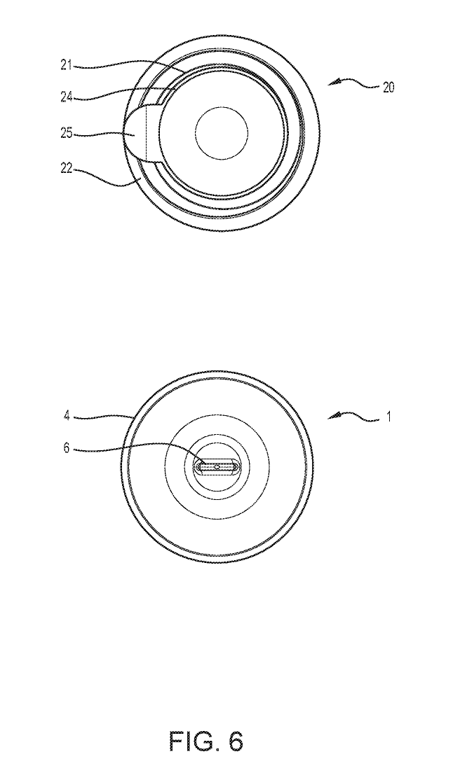

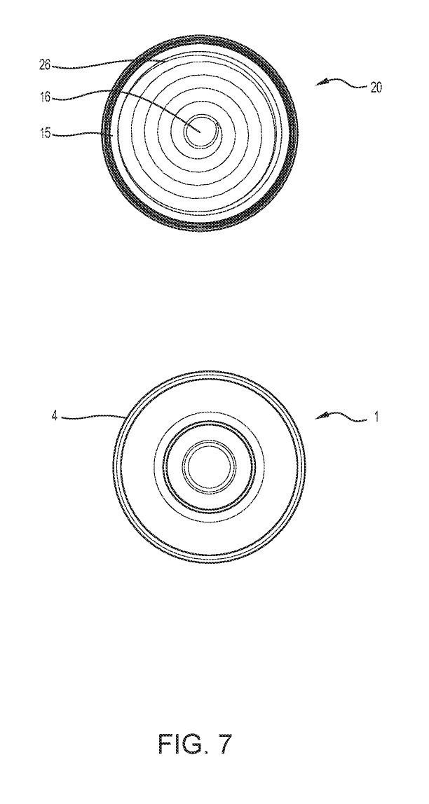

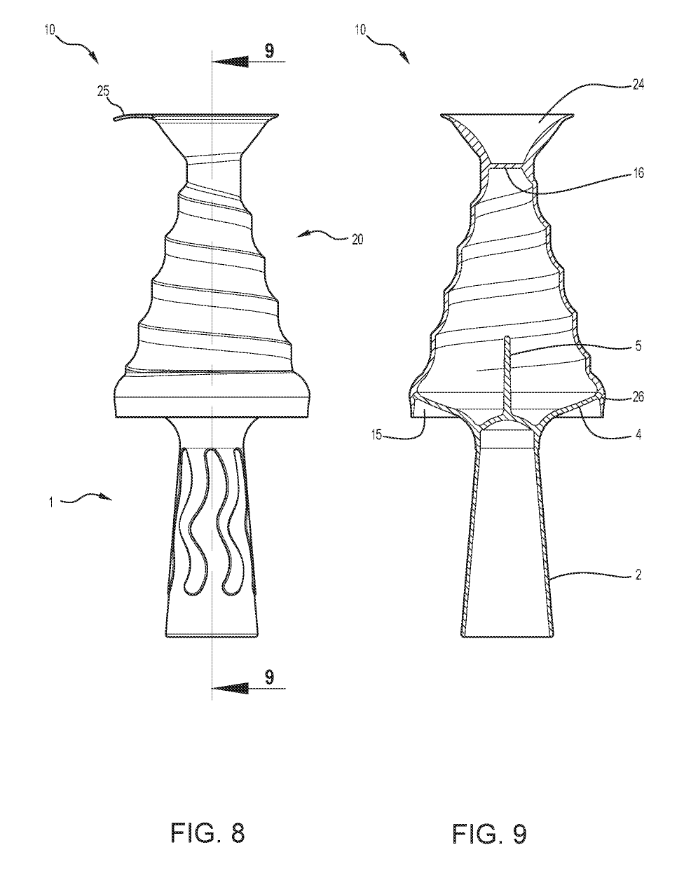

The mould 20 is preferably substantially circular in cross-section and, along the length dimension thereof, will exhibit a plurality of different diameters, tapering in a series of steps or stages from bottom to top to form a conical construction, as shown for example in FIG. 1. With reference to FIG. 1, and as discussed above, the mould 20 is open at one end 15 (that with the largest diameter) and closed at the other end 16. The mould constitutes a means for receiving and retaining milk, yoghurt, water, cordial or the like prior to freezing. The decreasing tapered nature of the mould from the open end to the closed end, together with the more resilient nature of the mould material relative to the handle assembly, also means that in some embodiments of the maker 1 when the contents have frozen into a confection the mould can be peeled off without damaging the frozen confection.

As shown in the drawings the mould 20, substantially circular in cross-section, has its largest outer diameter at the open free end thereof, being that end which, in use, is to overlay the flange 4 of the handle assembly 1. The mould 20 includes, at spaced-apart locations along the height dimension thereof, a series of lands 21, with adjacent lands 21 being interconnected by a web section 22. Such a configuration provides an enlarged/enhanced surface area, assisting in freezing or chilling of any foodstuff or the like to be located within the forming means 20 itself. Additionally, the lands 21 with interconnecting web 22 forms a spiral pattern around the length of the mould that translates into a corresponding, aesthetic pattern on the frozen confection.

In the preferred embodiment illustrated the mould is substantially conical in shape when viewed in side elevation, being tapered from the open free end (of greatest outer diameter) to the upper end thereof, exhibiting sections of differing/decreasing outer diameter. It should be understood, however, that the actual shape and/or configuration of mould can be varied and, given the more resilient nature of the mould relative to the handle assembly, in some embodiments the mould could have straight parallel sides.

At the closed end 16 of the mould 20 which is opposite to the open end 15 (the top as shown in FIG. 1), there is formed a section 23 having a substantially constant cross-section along the length dimension thereof, which terminates in a substantially conical or funnel-shaped hollow end-section in the form of a foot 24. Foot 24 forms a suction cup profile and includes at least one flap or the like member 25 extending laterally therefrom.

In use the mould 20 is located, standing on its funnel-like foot 24 (upside down to the orientation illustrated in FIG. 1), on a suitable flat surface, as for example a bench, table or the like. Upon the application of a slight downward pressure to the open end of the mould the overall mould 20 depresses to an extent, which results in that foot 24 being releasably affixed to the surface by suction, such then presenting or resulting in the mould 20 being in a substantially stable configuration to facilitate filling thereof with product for freezing. The suction created by the foot 24 suitably stabilises and supports the mould during the entire filling process and when full.

When filling is completed, the handle assembly 1 is upended and inserted into the open end 15 of the mould 20. Since the mould 20 is constructed from a material that is more resilient than the handle assembly, and preferably a flexible material, for example silicone, then despite the fact that the outer diameter of the flange 4 is greater than the inner diameter of the open free end 15, the peripheral wall of mould 20 will distend or distort to allow for passage of that member 4, until such time as it locates into engagement groove 26, preventing further inward movement and yet also providing resistance to outward movement, i.e. slipping out of engagement. The abutting contact ensures sealing around the entire periphery of the mould 20, preventing leakage of content. Once the handle assembly 1 is appropriately located within the mould 20, lifting of the tab 25 will result in releasing of suction in turn allowing the mould, with holder, to be picked up and located in a freezer or the like without particular regard to orientation in the freezer.

The mould 20 is adapted, in use, to have located therein the substance/foodstuff which is to be frozen or chilled for subsequent consumption. To facilitate such procedure the suction cup foot 24 constitutes a means for locating the mould 20 in an upright position relative to a bench, table or the like to allow for supported filling thereof. Once frozen, the mould can by easily removed from the frozen product (typically confectionery) allowing the user to consume the frozen confection attached to the stake 5 by holding the handle with the frozen confection oriented upwardly, the user's hands protected from dripping confection by upward facing flange 4.

Both the mould 20 and handle assembly 1 of the frozen confection maker 10 are readily able to be cleaned, to allow for re-use.

To summarise, the frozen confection maker 10 provides a re-usable easy to use and leak-proof means of forming a frozen product from a liquid (such as juice or yoghurt) and/or a flowable material (such as a more granular substance that can be frozen, e.g. choc chips).

The handle assembly 1, with or without the mould 20 associated therewith, is capable of being free-standing, as for example on a bench, table or the like because its open end with a larger diameter may be supported on a level surface. The handle 2 further lends itself to ready gripping by the user, whether an adult, youth, child or even toddler.

The stake 5 extending substantially centrally from the bowl-shaped flange 4 of the handle assembly 1 constitutes a surface area to be in contact with the frozen confection or foodstuff. The bowl-shaped flange 4 of the handle assembly 1 acts as a drip collector and is designed to fit tightly within the open end of the mould 20.

The mould 20, being preferably formed from a silicone material and by virtue of its physical configuration, affords an enhanced surface area to assist in freezing or chilling of the contents thereof. The material of construction lends itself to ready separation from the frozen content, to allow the user/consumer ready access thereto.

The foot 24 of the mould 20 allows that mould 20 to be located on a flat surface and remain substantially upright during filling, to minimise if not remove altogether the likelihood of spillage. The hollow truncated foot 24 allows the overall mould 20 to be releasably affixable, as by suction, to any given surface. The one or more flaps 25 allow or allows for ready release of the forming means 20 from that surface.

Finally, it is to be understood that the aforegoing description refers merely to preferred embodiments of the invention, and that variations and modifications will be possible thereto without departing from the spirit and scope of the invention, the ambit of which is to be determined from the following claims.

What is claimed is:

1. A frozen confection maker comprising:
a hollow mould having an open end and a closed end opposite the open end; and
a handle assembly having an elongate handle at a first end, a projection at a second end opposite the handle onto which a confection is frozen and an enlarged portion between the first and second ends that sealingly engages with the open end of the mould;
wherein the mould is made of a material that is more resilient than the material of the handle assembly.

2. The frozen confection maker as claimed in claim 1, wherein the open end of the mould flexibly surrounds the enlarged portion.

3. The frozen confection maker as claimed in claim 1, wherein a peripheral edge of the enlarged portion sealingly locates into an engagement groove on an inside of the mould at or near the open end.

4. The frozen confection maker as claimed in claim 1, wherein an outer diameter of the enlarged portion is larger than an inner diameter of the open end of the mould at which the enlarged portion engages the mould.

5. The frozen confection maker as claimed in claim 1, wherein the enlarged portion is a flange extending substantially normally from the handle.

6. The frozen confection maker as claimed in claim 5, wherein flange is bowl shaped to catch liquid when the projection directed upward.

7. The frozen confection maker as claimed in claim 1, wherein the mould has a foot at the closed end to support the mould in an upright position.

8. The frozen confection maker as claimed in claim 7, wherein the foot is shaped, together with the resilience in the mould material, to define the foot in the form of a suction cup.

9. The frozen confection maker as claimed in claim 8, wherein the foot includes a tab to assist in removing the foot when suctioned to a surface.

10. The frozen confection maker as claimed in claim 1, wherein the mould is conical in shape with the diameter of the open end being greater than that of the closed end.

11. The frozen confection maker as claimed in claim 1, wherein at spaced-apart locations along a length of the hollow mould, there are included lands of decreasing diameter, interconnected by webs, to create a spiral, tapering configuration on the mould.

12. The frozen confection maker as claimed in claim 1, wherein the mould is made of a flexible plastics or rubber material.

13. The frozen confection maker as claimed in claim 12, wherein the mould is made of silicone.

14. The frozen confection maker as claimed in claim 1, wherein the handle assembly is made of a hard plastics material.
